(19) United States
(12) Patent Application Publication
(10) Pub. No.: US 2017/0276200 A1
(43) Pub. Date: Sep. 28, 2017

(54) FRICTION MATERIAL AND METHOD FOR PRODUCING FRICTION MATERIAL

(71) Applicant: ADVICS CO., LTD., Kariya-shi, Aichi-ken (JP)

(72) Inventors: Masaru YAGIHASHI, Nagakute-shi (JP); Masaaki KOBAYASHI, Obu-shi (JP)

(73) Assignee: ADVICS CO., LTD., Kariya-shi, Aichi-ken (JP)

(21) Appl. No.: 15/511,039

(22) PCT Filed: Sep. 25, 2015
(86) PCT No.: PCT/JP2015/077025

§ 371 Date: Mar. 14, 2017

(30) Foreign Application Priority Data
Sep. 25, 2014 (JP) 2014-195324

(51) Int. Cl. F16D 69/02

(52) U.S. Cl. CPC F16D 69/026

(57) ABSTRACT

A friction material for a brake pad comprises a fibrous base material without a metal fiber, and comprises a binder and a friction modifier. The friction material comprises 0.3% to 2.0% by weight, relative to the entire friction material, of a non-crosslinkable polyolefin having a melting point higher than the melting temperature of the binder. The friction material can suppress increase in friction coefficient of a friction material during initial brake operation and reduce the occurrence of abnormal effects and squealing in low-temperature and high-humidity environments.

### TECHNICAL FIELD

The present invention relates to a friction material and a method for producing a friction material. Specifically, the invention relates to a friction material for a brake pad which can reduce the occurrence of abnormal effects and squealing after standing in low-temperature and high-humidity environments, and to a method for producing a friction material.

### BACKGROUND ART

It has conventionally been known that, upon braking after standing in relatively low-temperature and high-humidity environments such as rainy season and early morning, the brake effect becomes abnormally high. As a result, the shock at the braking time becomes significant, resulting in the occurrence of abrupt braking and brake squealing. These phenomena are caused by increase in friction coefficient (μ). Specifically, these phenomena would be caused mainly because the friction surface of the friction material of the pad absorbs moisture, so that the friction coefficient is apt to increase in the process of evaporating and drying the absorbed moisture; and because the rotor as a counterpart material is mirror-finished, leading to increase in its real contact area with friction material.

There have been proposed various strategies for suppressing the occurrence of such abnormal effects and squealing at the braking time after standing in low-temperature and high-humidity environments. For example, there have been reported methods of subjecting raw materials for friction material and a friction material itself of a pad to water repelling treatment, thereby avoiding the influences of moisture (for example, see Patent Literature 1). The technique described in Patent Literature 1 is directed to production of a friction material including a fibrous base material, a binder and a friction modifier, the friction material being subjected to water repelling treatment with a water-repellent into which finely powdered graphite is mixed. This suppresses increase in friction coefficient due to moisture absorption and reduces the occurrence of abnormal effects and squealing at the braking time. Conversely, there have been proposed a method of absorbing moisture from a frictional interface to avoid the influences of moisture, a method for obtaining frictional force which is hardly affected even in the presence of moisture, a method for imparting lubricity at low temperatures, a method for suppressing mirror-finishing of a rotor, and further a method for imparting damping properties to a friction material.

Especially in recent years, the customer demand associated with brake noise has further increased, also due to the improvement in silence of drive engines, with the advent of hybrid cars and electric cars. Therefore, none of the techniques proposed so far would sufficiently satisfy the customer demand. For example, the technique of Patent Literature 1 involves water repelling treatment of a friction material, but, disadvantageously, no countermeasures to abrasion powder greatly affecting the increase in friction coefficient have been established. Abrasion powder, which is necessarily present between the friction material of a pad and the contact surface of a rotor, aggregates and grows by moisture as a result of standing in low-temperature and high-humidity environments. Further, this powder would be embedded in the grooves and pores of the friction material, leading to increase in real contact area between the friction material and the rotor. Due to this, the friction coefficient increases. It can be said that taking countermeasures to such abrasion powder is one important issue for reducing abnormal effects and squealing which occur after standing in low-temperature and high-humidity environments.

The environment is now a growing global concern, and it is predicted that the regulation on the usage of copper in the North America will become a global regulation. Thus, the development of copper-free pads is urgently needed. The elimination of copper, however, reduces the brake effect at normal time, because of the disappearance of the adhesion frictional effect between the friction material and the rotor which comes in contact with this material under low-temperature conditions. The surface roughening effect by incorporation of copper abrasion powder into the rotor also disappears. Therefore, the friction surface of the rotor is smoothed, thereby causing, for example, increase in contact area between the friction material and the rotor. Consequently, friction coefficient of a cold working device increases. At high temperatures, on the other hand, the moistening effect obtained through reduction in film thickness due to softening of copper disappears, resulting in deteriorated high-temperature abrasion. Namely, copper elimination causes increase in friction coefficient after standing in cold environments, and deterioration of abnormal effects and squealing along with this. The countermeasures to the stabilization of the friction coefficient must be further reinforced in order to deal with such copper elimination.

### CITATIONS LIST

Patent Literature 1: JP H11-246845 A (JP 4021543 B)

### SUMMARY OF INVENTION

### Technical Problems

An object of the present invention is to provide a friction material for a brake pad which can suppress increase in friction coefficient of a friction material during initial brake operation and reduce the occurrence of abnormal effects and squealing in low-temperature and high-humidity environments, and a method for producing a friction material.

### Solutions to Problems

In order to solve the above problem, the present inventors, through earnest studies, have focused on the fact that not only a friction material itself, but also abrasion powder generated at the braking time is subjected to water repelling treatment, thereby minimizing the influences of moisture at the braking time after standing in low-temperature and high-humidity environments. As a result, the present inventors have found that, in a friction material including a fibrous base material, a binder and a friction modifier, a polyolefin having a melting point higher than the melting temperature of the binder is incorporated in a predetermined amount, and molten and liquefied by friction heat at the braking time, and that such a liquefied polyolefin can cover the friction surface of the friction material to make it water-repellent, and also can cover the abrasion powder surface to make it water-repellent. The present inventors have found that this can suppress increase in real contact area with the counterpart material of the friction material and increase in friction coefficient, and, at last, have accomplished the present invention.

Specifically, the present invention has the following characteristic features [1] to [5]

[1] A friction material including a fibrous base material, a binder and a friction modifier, wherein the friction material includes 0.3% to 2.0% by weight, relative to the entire friction material, of a polyolefin having a melting point higher than the melting temperature of the binder.

[2] The polyolefin is at least one polyolefin selected from polyethylene and polypropylene.

[3] The polyolefin has a melting point of 120° C. or higher.

By virtue of the above features [1] to [3], there can be provided a friction material which can reduce the occurrence of abnormal effects and squealing at the initial braking time, when the operation of a vehicle is started in low-temperature and high-humidity environments. The polyolefin, when incorporated, can make the friction material itself water-repellent and can also be molten by friction heat at the braking time to cover the friction surface of the friction material and the abrasion powder to make them water-repellent. Simultaneously, the polyolefin has a melting point higher than the melting temperature of the binder, and thus is not molten before the binder to cover the raw materials for friction material, and therefore does not deteriorate the function of the binder. Also, the polyolefin is incorporated in an amount of 0.3% to 2.0% by weight relative to the entire friction material, and thus can effectively make the friction material and the abrasion powder water-repellent without deterioration in brake effects or moldability. Thus, there can be provided a friction material having good performance, which can minimize the influences of moisture in low-temperature and high-humidity environments and can reduce the occurrence of abnormal effects and squealing at the initial braking time.

Especially, by virtue of the above feature [2], there can be provided a friction material including polyethylene and/or polypropylene as the polyolefin. The polyethylene and polypropylene can effectively contribute to the reduction in occurrence of abnormal effects and squealing at the initial braking time in low-temperature and high-humidity environments due to their properties such as melting point. Further, by virtue of the above feature [3], there can be provided a friction material including a polyolefin having a melting point of 120° C. or higher. Since phenol resins and the like generally used as binders have a melting temperature of 80° C. to 120° C., polyolefins having a melting point higher than the temperature are used, thereby making it possible to contribute to the reduction in occurrence of abnormal effects and squealing at the initial braking time in low-temperature and high-humidity environments without deteriorating the function of the binder

[4] A method for producing a friction material including a fibrous base material, a binder and a friction modifier, the friction material including 0.3% to 2.0% by weight, relative to the entire friction material, of a polyolefin having a melting point higher than the melting temperature of the binder,

the method including the heat curing step of heating a molded body obtained by heat molding a mixture of raw materials for friction material including the fibrous base material, the binder, the friction modifier and 0.3% to 2.0% by weight, relative to the entire friction material, of the polyolefin, at a temperature of 180° C. or higher and lower than 200° C. for 2 hours to 8 hours, thereby curing the binder.

[5] The heat curing step is conducted by heating at 180° C. to 190° C.

By virtue of the above features [4] to [5], there can be provided a method for producing the friction material according to the present invention which can reduce the occurrence of abnormal effects and squealing at the initial braking time when the operation of a vehicle is started in low-temperature and high-humidity environments. The heat curing temperature of the binder is adjusted to 180° C. or higher and lower than 200° C., thereby making it possible to produce a friction material including a polyolefin in an amount which can effectively make the friction material and the abrasion powder water-repellent. Also, temperatures within the above range would not disturb the progress of the heat curing of the binder which imparts the moldability and mechanical strength of the friction material. Especially, by virtue of the above feature [5], the heat curing temperature of the binder is adjusted to 180° C. to 190° C., thereby making it possible to further develop the above effects.

### BRIEF DESCRIPTION OF DRAWINGS

FIG. 1 summarizes the compositions of raw materials for friction material of the Examples and Comparative Examples of a friction material according to the present embodiment and their performance evaluation.

FIG. 2 shows results of confirmation of the effect of the friction material according to the present embodiment on the abrasion powders in the Examples and Comparative Examples.

### DESCRIPTION OF EMBODIMENTS

Hereinafter, an embodiment of the present invention is described. The present embodiment, however, is a mere illustration for specifically explaining the present invention, and the present invention would not be limited to the present embodiment.

### 1. Friction Material

Hereinafter, one embodiment of the friction material according to the present invention is described in detail. The friction material of the present invention includes a polyolefin having a melting point higher than the melting temperature of a binder, which is one of common components constituting a friction material, in a proportion of 0.3% to 2.0% by weight relative to the entire friction material.

The friction material of the present invention includes a fibrous base material, a binder, a friction modifier, and a polyolefin, but may include other raw materials for friction material that are used in the production of a friction material.

Examples of fibers used as the fibrous base material include organic fibers such as aramid fibers, cellulose fibers, acryl fibers and carbon fibers; inorganic fibers such as glass fibers, rock wool, ceramics fibers, potassium titanate fibers and wollastonite; and fibers of metals such as copper, bronze, aluminum and brass. These fibers may be used alone, or two or more thereof may be used in combination. The proportion of the fibrous base material to be incorporated is not particularly limited, but the fibrous base material only has to be added in a proportion of about 3% to 10% by weight relative to the entire friction material.

Conventionally, copper is generally used in friction materials for the purpose of stabilizing abrasion resistance and friction coefficient due to its high heat conductivity and excellent spreadability. However, it is predicted that copper elimination will become mainstream in the future from the viewpoint of the improvement in environmental performance such as the regulation on the usage of copper in the North America, but copper elimination is known to cause increase in friction coefficient after standing in cold environments and deterioration in abnormal effects and squealing along with this.

Here, the friction material of the present invention can be prepared in a copper-free manner. Even in a case where copper is included, the friction material can be prepared with a low percent by weight, for example, 5% by weight or less, of copper. The friction material of the present invention comprises a predetermined amount of a polyolefin, and thus can reduce increase in friction coefficient after standing in cold environments and the occurrence of squealing along with this, and such effects would not be deteriorated even when the friction material is prepared in a copper-free manner. Thus, the friction material of the present invention can satisfactorily be adapted to the copper elimination trend.

The binder has a role in binding the respective components incorporated in the friction material, and known materials can be used therefor. Preferably, thermosetting resins such as phenol resins, melamine resins and epoxy resins, and their modified products are indicated as examples. These materials may be used alone, or two or more thereof may be used in combination. Particularly preferably, the binder material is a phenol resin, and examples of the phenol resin include novolac type phenol resins and resonol type phenol resins. The proportion of the binder to be incorporated is not particularly limited, but the binder only has to be added in a proportion of about 5% to 20% by weight relative to the entire friction material.

The friction modifier has a role in modifying the friction performances of the friction material such as friction coefficient and abrasion, and can include various filling materials, polishing materials, lubricating materials and the like. Examples of the materials include friction dust such as cashew dust and rubber dust, calcium carbonate, barium sulfate, calcium hydroxide, magnesium oxide, graphite, mica, zircon, molybdenum disulfide, ceramic, copper powder, brass powder, zinc powder, aluminum powder and foamed vermiculite. Especially, alumina, silica, zirconia, zirconium silicate or the like may be added as a grinding material, and graphite, antimony trisulfide, molybdenum disulfide or the like may be added as the lubricating material. These materials may be used alone, or two or more thereof may be used in combination. The proportion of the friction material to be incorporated is not particularly limited, but it only has to be added in a proportion of about 20% to 80% by weight relative to the entire friction material.

The friction material of the present invention is designed so as to include a predetermined amount of a polyolefin. The polyolefin is an olefin polymer. The olefin is the generic name of hydrocarbon compounds having at least one carbon-carbon double bond in the molecule, and examples thereof include ethylene, propylene, 1-butene, 1-hexene, 4-methyl-1-pentene, and 1-hexene. The polyolefin may be either a homopolymer of an olefin or a copolymer of two or more olefins. When the polyolefin is a copolymer, any copolymer such as a random copolymer, an alternating copolymer or a block polymer, may be used. Also, a mixture of these polymers may be used. Specifically, polyethylene and polypropylene can preferably be utilized as the polyolefin.

Polyethylenes having different properties such as density and molecular weight can be obtained depending on conditions such as the pressure and catalyst employed in the polymerization, but any polyethylene can be utilized. For example, polyethylenes produced by radical polymerization have many branches and high crystallinity, and thus become low-density polyethylenes (density: 0.91 to 0.92) having a low density, and polyethylenes produced by polymerization using a Ziegler-Natta catalyst have less branches and high crystallinity, and thus become high-density polyethylenes (density: 0.94 to 0.95) having a high density. Examples of the polyethylene include linear low-density polyethylenes and ultra high polymer polyethylenes.

The polyolefin used in the present invention has a melting point higher than the melting temperature of the binder. Many thermosetting resins preferably used as binders, such as phenol resins, are heated to be molten, softened and fluidized, but, along with increase in temperature, gradually cause an intermolecular cross-linking reaction by heat, form a three-dimensional network structure and have setting property. Through the use of such a property, the respective raw materials for friction material are dispersed and bound in the three-dimensional network structure, thereby molding a friction material. In other words, the friction material is molded by thermosetting the binder through the heat treatment of a mixture of the raw materials for friction material including the binder. However, if the polyolefin has a melting point lower than the melting temperature of the binder, the polyolefin would be molten before the binder, so that the respective raw materials for friction material would be covered with the polyolefin. As a result, the binding property to the raw materials for friction material by the binder would be inhibited, thereby causing difficulty in molding, and the strength of the friction material is likely to be disadvantageously reduced. In order to avoid such undesirable phenomena, it is necessary to select a polyolefin having a proper melting point.

Specifically, it is only necessary to select a polyolefin having a proper melting point according to the type of the binder used. For example, since phenol resins generally used as binders have a melting temperature of about 80° C. to 120° C., a polyolefin having a melting point higher than this temperature is selected. A polyolefin having a melting point of preferably 80° C. to 120° C. or higher, particularly exceeding 120° C. is selected. Some of the polyethylenes described above have different properties in, for example, density and molecular weight. Above all, high-density polyethylenes having a melting point of 120° C. to 140° C. and ultra high polymer polyethylenes having a melting point of 125° C. to 135° C. can be particularly preferably utilized. Polypropylenes can also be particularly preferably utilized since it has a melting point up to about 165° C.

On the other hand, the polyolefin used in the present invention must be molten by friction heat at the braking time. The present invention utilizes the property of a polyolefin melting by friction heat at the braking time to cover the friction surface of the friction material with the polyolefin for making it water-repellent and also to cover the surface of the abrasion powder generated at the braking time therewith for making it water-repellent, thereby suppressing increase in real contact area of the friction material and also increase in friction coefficient.

Here, the abrasion powder is generated by pressure-welding of the friction material onto the friction surface of a counterpart material such as a rotor, thereby causing abrasion of the friction material. Because of good conformability between such abrasion powders and water, upon attachment of water to the abrasion powders, the abrasion powders are attracted by surface tension to bind and aggregate together. The aggregated abrasion powders are embedded in the groove and pore portions in the friction surface of the friction material, thereby smoothing the friction surface. Thus, the real contact area between the friction material and the counterpart material is increased, and, along with this, the friction coefficient is increased, leading to the occurrence of undesirable events such as abnormal effects and squealing.

The incorporation of a polyolefin which is molten by friction heat at the braking time can make water-repellent not only the friction surface of the friction material, but also abrasion powder, thereby making it possible to prevent the aggregation and growth of the abrasion powder by moisture. Consequently, the abrasion powder would be smoothly eliminated from the inside of the friction surface. Accordingly, it is made possible to suppress increase in real contact area of the friction material even in low-temperature and high-humidity environments and also increase in friction coefficient. Thus, it is made possible to reduce the occurrence of abnormal effects and squealing at the braking time after standing in low-temperature and high-humidity environments. Here, the polyolefin, which is a component of the friction material, would also constitute the abrasion powder, but is molten by friction heat to cover other abrasion powders, and thus contributes to the development of the above effects.

For the above reasons, polyolefins which would not be molten by friction heat at the braking time are unsuitable for use, and thus the melting point of the polyolefin is preferably 140° C. or lower. For example, the crosslinkable polyolefin as disclosed in JP H11-269278 A is unsuitable for use in the present invention. The polyolefin contained in the friction material of the present invention is requested to be molten by friction heat of a brake. On the other hand, the crosslinkable polyolefin disclosed in the above patent literature is intended to impart mechanical strength to the friction material. Therefore, it is essential that the polyolefin has a crosslinking structure, and further, it is regarded as being preferable, from the viewpoint of further improvement in mechanical strength of the friction material, to increase the crosslinking density via a silane group and to cause the crosslinking structure with the other raw materials for friction material in the polyolefin. In other words, the cited invention can be said to aim at developing the function as a part of the binder which is a conventional raw material for friction material. The crosslinkable polyolefin having a dense crosslinking structure is not molten by friction heat, and is used for a purpose which is different from that of the present invention. Hence, if the crosslinkable polyolefin having a dense crosslinking structure, as disclosed in the above patent literature, is used, the effects of the present invention cannot be obtained. The present invention is directed to a non-crosslinkable polyolefin.

The polyolefin is added in a proportion of 0.3% to 2.0% by weight relative to the entire friction material. When the proportion of the polyolefin to be incorporated is less than 0.3% by weight, the water-repellent effect is reduced or disappears. Whereas, when the proportion exceeds 2.0% by weight, the brake effect at normal time is reduced, and the moldability is worsened, so that the effects of the present invention cannot be obtained.

Due to the above configuration, the incorporation of the polyolefin can make the friction material itself water-repellent, can cover the friction surface of the friction material with the polyolefin by friction heat at the braking time to make it water-repellent, and also can cover the surface of the abrasion powder generated at the braking time to make it water-repellent. Thus, it is made possible to prevent the aggregation and growth of the abrasion powder by moisture. Consequently, the abrasion powder would be smoothly eliminated from the inside of the friction surface. Thus, there can be provided a friction material which can suppress increase in real contact area of the friction material even in low-temperature and high-humidity environments and increase in friction coefficient, and also can suppress abnormal effects and squealing after standing.

The friction material of the present invention can be applied, for example, to pads for disk brakes in vehicles and the like, but is not limited to these applications. The frication material can be applied to other techniques for which conventionally known friction materials are needed, such as brake shoes. The produced friction material can be integrated, as a back plate, with a plate-like member such as a metal plate to be used as a brake pad.

### 2. Method for Producing a Friction Material

Hereinafter, an embodiment of the method for producing a friction material according to the present invention is described in detail. The method for producing a friction material according to the present invention has the heat curing step of heating a molded body obtained by heat molding a mixture of raw materials for friction material including the fibrous base material, the binder, the friction modifier and 0.3% to 2.0% by weight, relative to the entire friction material, of the polyolefin, at a temperature of 180° C. or higher and lower than 200° C. for 2 hours to 8 hours, thereby curing the binder.

Firstly, the raw materials for friction material including the fibrous base material, binder, friction modifier and the like as described above are weighed, and are uniformly mixed. At this time, the polyolefin is weighed so that the proportion thereof is 0.3% to 2.0% by weight relative to the entire raw materials for friction material, and these raw materials for friction material are uniformly mixed. Mixing can be carried out by charging the raw materials into a mixer such as a Henschel mixer or a Lödige mixer, and is carried out, for example, at ordinary temperatures for about 10 minutes. At this time, mixing may be carried out while the mixer is cooled by a known cooling means so as to prevent the temperature rise of the mixer. According to need, raw materials that are apt to be segregated by mixing, such as dust and metal fibers, may be pretreated with a viscous aqueous solution.

Then, a predetermined amount of the resultant mixture is weighed, and pressurized for pre-molding. Then, this pre-molded mixture is pressurized and warmed for heat molding. Heat molding can be carried out, for example, by charging the pre-molded mixture into a heat molding die to hot-press this product. At this time, the pre-molded mixture may be charged into the heat molding die while a back plate, which is a plate-like member such as a metal plate, is superposed onto the product. A back plate preliminarily cleaned and then subjected to appropriate surface treatment and having an adhesive applied onto its side on which the pre-molded mixture is placed can be used. Heat molding is preferably carried out at a molding temperature of 140° C. to 160° C., particularly preferably 150° C. and a molding pressure of 100 kgf/cm² to 250 kgf/cm², particularly preferably 200 kgf/cm² for a molding time of 3 minutes to 15 minutes, particularly preferably 10 minutes.

The resultant molded article is further heated, and then the curing of the binder is terminated. The curing temperature for heat curing is preferably set to 180° C. or higher and lower than 200° C., particularly preferably 180° C. to 190° C. The curing time is inversely proportional to the curing temperature. Curing can be carried out for a short time when the curing temperature is set to be high, whereas a longer time is required for curing when the curing temperature is set to be low. Preferably, curing can be carried out for 2 hours to 8 hours.

Further, according to need, the method may include the polishing step of polishing the friction material surface to form a friction surface.

In the method for producing a friction material according to the present invention, the setting of the heat curing temperature is important. When the curing temperature falls beyond the above range, the polyolefin is completely molten or causes a thermal degradation reaction, and thus disappears from the friction material. Therefore, the friction material of the present invention including the above predetermined amount of the polyolefin cannot be obtained. For example, JP 2008-69314 A and JP 2009-221303 A disclose techniques regarding a friction material which utilizes a polyolefin. Such techniques, however, involve heat treatment at a very high temperature of about 300° C., which falls beyond the above heat curing temperature range of the present invention. That is, the polyolefin is utilized to form a pore portion in a friction material, and is not intended to remain in the final friction material. In this regard, the cited inventions are different in purpose from the present invention, and it is necessary to properly manage the heat curing temperature for the purpose of obtaining the friction material of the present invention. On the other hand, when the curing temperature is lower than the above range, the binder cannot properly be cured, so that the binding property to the respective raw materials for friction material would be inhibited, thereby causing difficulty in molding. Also, the strength of the friction material is likely to be disadvantageously reduced.

### EXAMPLES

Hereinafter, the present invention is specifically described by way of Examples. The present invention, however, is not limited to these Examples.

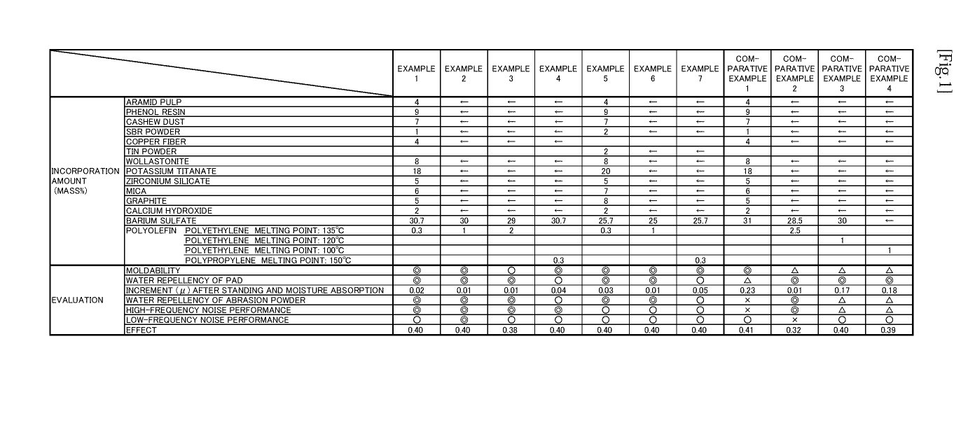

In these Examples, friction material compositions of Examples 1 to 7 and Comparative Examples 1 to 4 were obtained by incorporating raw materials for friction material in accordance with their amounts to be incorporated as shown in FIG. 1. Incidentally, the unit of the amounts of the raw materials for friction material to be incorporated in the table is % by weight relative to the entire friction material composition. This friction material composition was mixed in a Lödige mixer for 10 minutes, and this mixture was pressurized and heated under the following conditions: a molding temperature of 160° C., a molding pressure of 200 kgf/cm² and a molding time of 10 minutes. Subsequently, this molded product was cured at 190° C. for 4 hours.

The prepared friction materials of Examples 1 to 7 and Comparative Examples 1 to 4 were evaluated in terms of the following items.

### (Moldability of Friction Material)

The cracks formed in the friction materials after molding were observed at a visual level to evaluate their moldability on a four-level scale. Specifically, the moldability was determined, based on the presence or absence of cracks and their states, as follows: very good: “⊙”; good: “∘”; barely usable: “Δ”; and unusable: “×”.

### (Water Repellency of Friction Material)

Distilled water was dropped onto the friction surfaces of the friction materials to evaluate their water repellency, based on the shape of droplets after 5 minutes, on a four-level scale. The water repellency was determined as follows: when the shape of the liquid droplets was very closely spherical, “⊙” indicating good water repellency; when the liquid droplets collapsed and exhibited a semi-elliptic shape, “∘” or “Δ”, depending on the level of collapse of the liquid droplets; and when the liquid droplets could not retain their shape and water was absorbed into the friction materials, “×” indicating no good water repellency.

### (Increase in Friction Coefficient (μ) at the Time of Standing and Moisture Absorption)

After lapping conducted in accordance with JASO C406, the friction coefficient under the condition where a temperature was 20° C. and a humidity was 55% was measured, before and after standing in a humid environment (humidity of 80%) at 30° C. for 8 hours, thereby obtaining the increment of the friction coefficient in a humid environment.

### (Water Repellency of Abrasion Powder)

After the end of the test set forth in the above section (Increase in friction coefficient at the time of standing and moisture absorption), abrasion powder was collected from a pad surface, and charged into a glass bottle filled with distilled water. The glass bottle was manually shaken ten times, and then the water repellency was evaluated based on the state of cloudiness of water after still standing for 10 minutes. The water repellency was determined as follows: when water was not cloudy in a state where abrasion powder floated on the water surface, “⊙” indicating very good water repellency; when water was slightly cloudy, “∘” or “Δ”, depending on the state of cloudiness and floating state of the abrasion powder; and when water was cloudy without floating abrasion powder, “×” indicating no good water repellency.

### (High-Frequency Noise Performance and Low-Frequency Noise Performance)

In accordance with JASO C427, a test was conducted under the following conditions: an initial braking speed of 50 km/hr., a braking deceleration of 0.15 G and a prior-to-braking temperature of 70° C., 100° C. and 150° C., while 1,000 braking operations were conducted at the respective temperatures. The number of times of generation of high-frequency noise (500 Hz or higher) and low-frequency noise (200 Hz to 400 Hz) during the test was measured, and the squealing occurrence state was evaluated on a four-level scale. The noise performance was determined as follows: when no squealing occurred, “⊙” indicating very good noise performance; when subtle squealing occurred, “∘”; when squealing slightly occurred, “Δ,” and when squealing frequently occurred, “×” indicating no good noise performance.

### (Average Friction Coefficient)

In accordance with JASO C406, the average friction coefficient at a prior-to-braking speed of 50 km/hr. was measured in an environment where a temperature was 20° C. and a humidity was 58%.

FIG. 1 shows the results. Examples 1 to 7 of the present invention presented good results in terms of the moldability and the water repellency of the pad and the abrasion powder. Thus, it was revealed that the polyolefin can make the friction material itself and the abrasion powder water-repellent without deterioration in moldability of the friction material. On the other hand, Comparative Example 1 including no polyolefin had very inferior water repellency of the abrasion powder, and thus it was clear that the water repellency confirmed in the Examples of the present invention was derived from the polyolefin. Also, Comparative Example 2 including 2.5% by weight of a polyolefin was confirmed to have inferior moldability, and the importance of the proportion of the polyolefin to be incorporated could be understood. It was also confirmed that, when the melting point of polyolefin becomes low, the moldability of the friction material becomes inferior (Comparative Examples 3 and 4), and it could be understood that the melting point of the polyolefin is also an important element for providing the effects of the present invention.

Also, it was revealed that Examples 1 to 7 of the present invention can suppress increase in friction coefficient at the time of standing and moisture absorption, and have good noise performance. On the other hand, Comparative Example 1 including no polyolefin was confirmed to have an increased friction coefficient at the time of standing and moisture absorption, and was inferior also in high-frequency noise performance. Also, Comparative Example 2 was confirmed to have inferior low-frequency noise performance, and the importance of the proportion of the polyolefin to be incorporated could be understood also from the viewpoint of noise performance.

From the above results, it was revealed that the friction material of the present invention can make the pad and abrasion powder water-repellent and also can effectively suppress increase in friction coefficient at the time of standing and moisture absorption. Thus, it could be understood that the friction material, also at the time of standing and moisture absorption, exhibits good friction performance and can prevent the occurrence of abnormal effects and squealing.

While the friction materials of Examples 5 to 7 included no copper in their raw materials, their performance was not greatly affected as compared with the case where they included copper (comparisons between Examples 1 and 5, between Examples 2 and 6, and between Examples 4 and 7). Thus, it was revealed that the friction material includes a predetermined amount of a polyolefin and can thus be adapted to copper elimination.

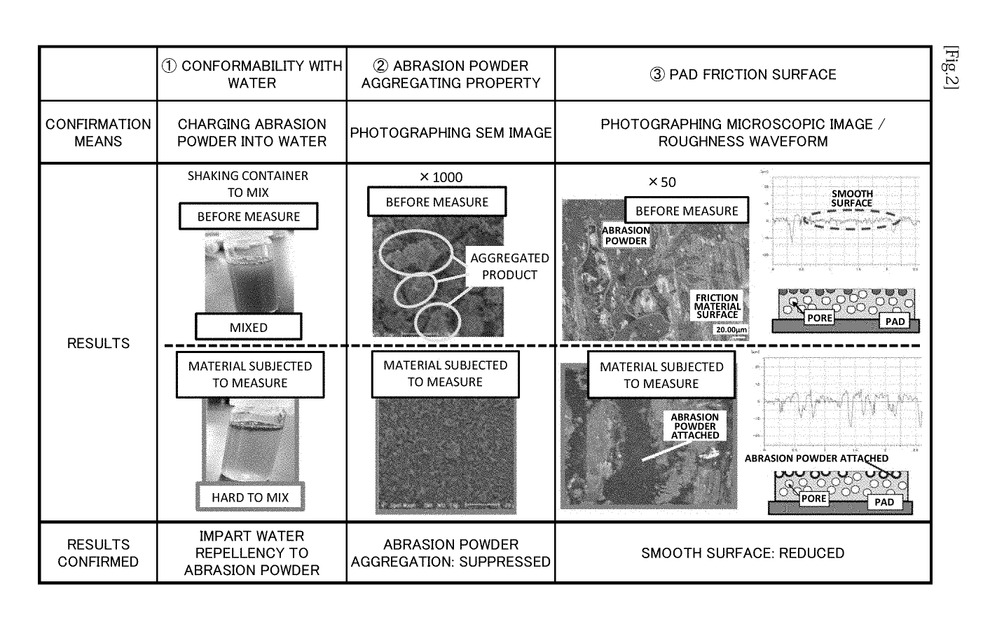

FIG. 2 shows the results of confirmation of the effect on abrasion powder. The lower column in FIG. 2 indicates the results of incorporation of a predetermined amount of a polyolefin in the frictional material as a measure for making the abrasion powder water-repellent, and the upper column indicates the results before such measure was taken.

The conformability with water was evaluated based on the state of cloudiness of water after the procedures of collecting abrasion powders before and after the measure, charging the powders into a glass bottle filled with distilled water, shaking this bottle and then leaving it to stand. It was confirmed that the abrasion powder after the measure was not mixed with water, but that the abrasion powder before the measure was mixed with water. Thus, it could be understood that the polyolefin can impart water repellency to the abrasion powder.

The abrasion powder aggregating property was evaluated by observing the state of abrasion powders with a scanning electron microscope (SEM: ×1000). The abrasion powder after the measure could not be confirmed to aggregate, but the abrasion powder was confirmed to aggregate into a large mass. Thus, it could be understood that the polyolefin can suppress aggregation of the abrasion powder.

The state of the friction surface of the pad was observed with a microscope and evaluated. After the measure, abrasion powder was confirmed to be attached, in a thin layer state, to the friction surface, but did not clog the grooves or pore portions formed in the pad. This matter was confirmed also from the roughness waveform, and a good rough surface was maintained. Before the measure, on the other hand, abrasion powder aggregated and adsorbed on the friction surface, and was embedded in the grooves and pore portions. Also from the roughness waveform, it could be confirmed that the friction surface became a smooth surface so that the real contact area increased. Thus, it could be understood that the polyolefin suppresses aggregation of abrasion powder and formation of a smooth surface.

It is clear that not only the friction material itself, but also the abrasion powder was made water-repellent, thereby making it possible to provide the effect of suppressing the friction coefficient at the braking time after leaving and the effect of reducing squealing, as shown in FIG. 1.

### INDUSTRIAL APPLICABILITY

The friction material and the method for producing a friction material according to the present invention can be applied to products for which conventionally known friction materials are needed, such as pads and brake shoes for disk brakes in vehicles and the like.

1. A friction material comprising:
a fibrous base material without a metal fiber;
a binder; and
a friction modifier, wherein
the friction material comprises 0.3% to 2.0% by weight, relative to the entire friction material, of a non-crosslinkable polyolefin having a melting point higher than a melting temperature of the binder.

2. The friction material according to claim 1, wherein the non-crosslinkable polyolefin is at least one non-crosslinkable polyolefin selected from polyethylene and polypropylene.

3. The friction material according to claim 1, wherein the melting point of the non-crosslinkable polyolefin is 120° C. or higher.

4. A method for producing a friction material including a fibrous base material without a metal fiber, and including a binder and a friction modifier, the friction material including 0.3% to 2.0% by weight, relative to the entire friction material, of a non-crosslinkable polyolefin having a melting point higher than a melting temperature of the binder,
the method comprising:
a heat curing that includes heating a molded body obtained by heat molding a mixture of raw materials for friction material including the fibrous base material, the binder, the friction modifier and 0.3% to 2.0% by weight, relative to the entire friction material, of the non-crosslinkable polyolefin, at a temperature of 180° C. or higher and lower than 200° C. for 2 hours to 8 hours, thereby curing the binder.

5. The method for producing a friction material according to claim 4, wherein the heat curing includes the heating at 180° C. to 190° C.

6. The method for producing a friction material according to claim 4, wherein the friction material includes 1.0% to 2.0% by weight, relative to the entire friction material, of the non-crosslinkable polyolefin.

7. The method for producing a friction material according to claim 4, wherein the melting point of the non-crosslinkable polyolefin is higher than 120° C.

8. The method for producing a friction material according to claim 4, wherein the melting point of the non-crosslinkable polyolefin is higher than 120° C. and lower than or equal to 140° C.

9. The method for producing a friction material according to claim 4, the method further comprising preparing a mixture of raw materials for friction material by uniformly mixing weighed raw materials for friction material including the fibrous base material, the binder, the friction modifier, and the non-crosslinkable polyolefin.

10. The friction material according to claim 1, wherein the friction material comprises 1.0% to 2.0% by weight, relative to the entire friction material, of the non-crosslinkable polyolefin.

11. The friction material according to claim 1, wherein the melting point of the non-crosslinkable polyolefin is higher than 120° C.

12. The friction material according to claim 1, wherein the melting point of the non-crosslinkable polyolefin is higher than 120° C. and lower than or equal to 140° C.

13. The friction material according to claim 2, wherein the melting point of the non-crosslinkable polyolefin is 120° C. or higher.
